(19) United States
(12) Patent Application Publication
(10) Pub. No.: US 2021/0279690 A1
(43) Pub. Date: Sep. 9, 2021

(54) PATHFINDER

(71) Applicant: Darrell Thompson, II, Brooklyn, NY (US)

(72) Inventor: Darrell Thompson, II, Brooklyn, NY (US)

(21) Appl. No.: 17/315,874

(22) Filed: May 10, 2021

Related U.S. Application Data
(60) Provisional application No. 63/032,193, filed on May 29, 2020.

(51) Int. Cl. G06Q 10/10; G06Q 50/26; G06F 16/2457; H04L 29/06

(52) U.S. Cl. CPC G06Q 10/1053; H04L 63/0428; G06F 16/24575; G06Q 50/26

(57) ABSTRACT

A system and method constructed from blockchain-based components for managing employment postings and candidate recruitment data. This system differs from what currently exists; it aids hiring managers in posting open roles, as well as to allow collaborative dialogue with job-seekers. Additionally, the system allows job seekers to consensus match resumes by the hiring manager's precise requirements, removing the need for tailoring resumes to the job. The blockchain components include the ‘Hyperledger Fabric IROHA’ for data processing; ‘Sumeragi’ algorithm for data consensus; ‘Blockchain Reference Architecture’ (i.e., RA) for data management via private-permissioned blockchain folders. The blockchain-based system may collect, process, and distribute data in real-time via tailored algorithms, ‘Smart Contract Data Triggers’ (SMDT's), associating data dispatch via Sumeragi consensus. The systems language code for peripherals (i.e.; data transfer, SMDT algorithms, GUI tools, RA access points, etc.) may be constructed via Logical Data Flow Descriptions (LDFD) and a User-Story Map.

### CROSS-REFERENCE TO RELATED APPLICATIONS

This application claims the benefit of U.S. Provisional Application No. 63/032,193, filed May 29, 2020, the disclosure of which is incorporated herein by reference.

### BACKGROUND OF THE INVENTION

Human Resources personnel often re-write job postings and requests for new hires to search for ‘the best fit’ for an open role, primarily to align with the organization's culture; although the initial request for new hires and posting new job requests are exclusively made by hiring managers to fill a needed role.

Despite how qualified candidates are, a vast majority still seem to fall through when it comes to a company's culture. (i.e.; the way an organization's people interact with each other, the values they hold, and the decisions they make).

The person making the decision should have a good sense regarding fit; hence, the term, ‘fit’ is vague, and very much subject to definition by the hiring authority (i.e.; the hiring manager).

Also, the very good chance exists that, having narrowed down to the hiring manager's short list as a candidate (i.e.; background evaluations, etc.), that prospective candidate is already good enough from the perspective of the hiring manager, and are equally likely to be easily hirable.

This is not always the case, however. Every so often, the outcome of HR's revisions in their ‘best-fit’ search has led to jobs posted for lengthy periods, including, but not limited to, illegally citing ‘cost-value’ of retaining certain applicants (RE: 42 U.S.C. Sections 6101-6107). More often than less, the problem that these actions cause, are a reduced amount of objective and/or equitable employment prospects.

A further problem exists, as it applies to an external search of applicants. If an applicant files for a job thru a recruiter or employment service, and by recruiters further re-editing and replicating the job post onto their own hosted website, this results in charging an employer a ‘finders-fee” of 20% of an applicant's salary, if said applicant is hired.

A still further problem exists, as bias in hiring practices by recruiters have also arose by these mentioned actions. Either or individually, these have led to hardships, both, financially and utilized time, for the prospective job-seeker.

The situation leads to further hardship, as HR departments, recruiters and employment services organizations choose to use Applicant Tracking Systems (ATS) to post job postings. Since an ATS-based job posting can generate huge numbers of applicants, this presents a hardship on potential job seekers, as they now navigate the multifaceted conditions of the posted role.

A problem with that approach is, the ATS's AI (i.e.; artificial intelligence algorithms), is the “how” that the system follows to find a resume. The AI does not deliberate on how your resume is written (i.e.; format), nor, the information it delivers (i.e.; context). Thus, the prospects of a resume to be found in an ATS search have falsely encouraged potential job-seekers to ‘tailor’ a resume for ‘matching’ each specific job description and application filed via an ATS.

This approach incurred an added problem. A market grew for creating ‘optimized-ATS resumes’, proposed to increase the chances of a resume to be found via ATS. Thru the claim of making resumes ‘easier’ for the ATS to read, by adding industry specific context (aka ‘buzzwords’), a cost to “ATS-optimize” a typical resume could exceed hundreds, or perhaps thousands of dollars.

This approach incurred an additional problem. Given that most Commercial-Off-the-Shelf (COTS)-based resume parsing software can read 50 to 100 resumes per CPU per second, this controls the real number of resumes that are, in fact, personally read (i.e.; the “6-second-rule”).

Thus, irrespective of its context rebuilding, if a resume is actually viewed for six (6) seconds by a real person, this action, by design, lowers the chances of the resume being considered.

Thus, the object of the present invention is to disclose a novel system where dual functions occur. First, to ensure a hiring manager's posted job requests are according to the valid details of the role. Second, to allow a job-seeker to submit a clear resume, which balances the specifics of the hiring manager's posted job request. This resume is to be specifically accessible to the hiring manager.

This approach cancels the earlier mentioned problems. By allowing the job seeker to submit their resume directly to the hiring manager by secured or encrypted folders, this removes the need for posting ‘optimized’ resumes on job boards. Furthermore, by posting job requests based upon the hiring managers needs of the role—again, by secured or encrypted folders—the job postings are fulfilling the specifics of the role, as advertised. The invention claimed here solves this problem.

The invention consists of a blockchain-based system and method for hiring managers to build and post job requests using information retrieved from the US Department of Labor (USDOL). It enables prospective job-seekers to construct and post a solid, accurate resume constructed via USDOL criteria aligning to the background of the job seeker. Finally, by applying for job requests by means of effectual matching of the background to the specifics of the job post, the need for “re-edited” job requests no longer apply.

The USDOL data is annually updated, comprising of data from all job markets; public, private, Federal, State and City, to approve conditions of employment and hiring. The data comprises of codes, labeled SOC and O'Net, which details occupation classification, as well as salary, benefits, and required skills.

The Standard Occupational Classification (SOC) data, organizes 867 detailed occupations, combining 459 general occupations through 98 minor and 23 major groups, while the Occupational Information Network (O'Net) link current job descriptions to their job-related data and skills. The O'Net system replaced the former ‘Dictionary of Occupational Titles’ (DOT) in the 1990's.

The present invention elements are novel to aid hiring managers to construct and apply the USDOL data to create and post job requests. These new job requests can be scaled to the developing needs of the workforce through the viewpoint of the hiring manager; for example, entry-level jobs for College Graduates, Executive-Level positions, Veterans, disabled job seekers, State/Federal Vocational Rehabilitation services, etc.

This approach cancels the earlier mentioned problems. A further object of the present invention is to support job seekers in defining USDOL-based job description data, to construct a template that correctly reviews their skill sets and background. This new data can be cast into a proven context format generally referred to as, ‘Write Once, Read Many’ or WORM.

By repressing the use of re-edited job postings and job descriptions which directly influence job-searching prospects, this approach cancels the earlier mentioned problems. By following the hiring managers needs of the role as advertised, this approach cancels the earlier mentioned problems triggered by unjust and biased hiring.

### SUMMARY OF THE INVENTION

This invention relates to a system and method for management of job posting and candidate data to assist in near real time matching of a hiring manager's detailed job requirements to a prospective job seeker.

The system may incorporate software architecture comprised of a presentation (GUI) tier and a middleware (domain) tier, commonly referred to as Blockchain Reference Architecture.

The system may be comprised of C++, JavaScript, and Android data libraries (i.e.; environments).

The system may be comprised of a ‘search engine’-type component called a blockchain Hyperledger, that allows the system to reach consensus and review results of data gathered from blockchain ledgers.

The system may use a blockchain-based component called a Hyperledger Fabric, to perform network-related managing functions.

The system may use the Hyperledger to process data input, including but not limited to, the consensus alignment thru data, of an accrued experience definition (i.e.; specific data points) of an applicant to the experience definition of the role, and may include an annotation tool to simplify and compile user defined data points as advertised by the hiring manager.

The system may use alignment and analysis tools that will process ensuing protocols linked to a query tool for evaluating details that are unique to the data consensus, and compile the total data into a document.

The system may use additional tools for allowing near-real-time broadcasts of the compiled data via an algorithmic protocol referred to as a ‘trigger’.

The system may use additional tools to prepare the total data into a document, and broadcast it to the participating entities within the Blockchain.

It is not unusual to one skilled in the art, that the invention may take numerous forms of device and system configurations as well as accommodate a diversity of functions, as it will reasonable to use a code compiler for creating the related machine code.

Various advantages of this invention will become apparent to those skilled in the art from by following the detailed description of the preferred embodiment, when read in the light of the accompanying drawings.

### BRIEF DESCRIPTION OF THE DRAWINGS

FIG. 1 is an exemplary schematic, prepared thru Logical Data File Description (LDFD), of the workflow of the invention.

FIG. 2 is an exemplary schematic, prepared thru Logical Data File Description (LDFD), of the workflow of the process referred to as “Bid Sheet’ Retrieval of Job Seekers (SCD Trigger/Posted Role by Matched SCD TRIGGER/Job Seeker Profile).

FIG. 3 is an exemplary schematic, prepared thru Logical Data File Description (LDFD), of the workflow of the process referred to as ‘Hiring Manager Accesses Job Description via O'Net consensus within Hyperledger IROHA (Sumeragi)’.

FIG. 4 is an exemplary schematic, prepared thru Logical Data File Description (LDFD), of the process referred to as a user-story map (i.e.; workplan), involving the visual-aid construction of the invention.

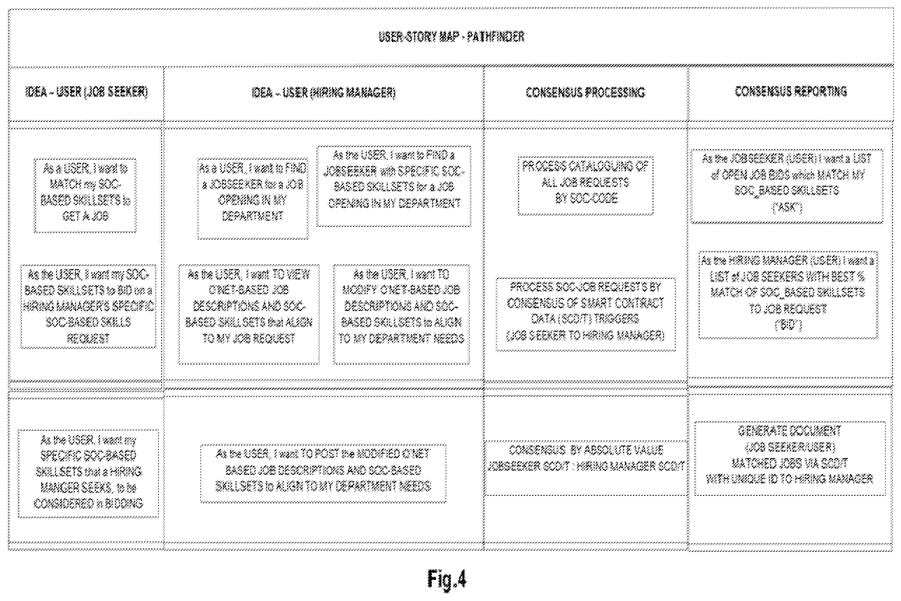

### DETAILED DESCRIPTION OF THE INVENTION

In describing the invention, it will be understood that several techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. As an example, it is understood that PATHFINDER—by name—refers not just to the system, but is also the title of the invention.

In its basic explanation, the term blockchain' describes the process that allows digital information to be recorded and distributed, but not edited. Simply put, in a blockchain, all transactions are viewable to all parties within the ‘chain’, but without the ability to change the integrity of the transaction, end to end.

There are various components that make the final blockchain package. One example is called a ‘smart contract’. A smart contract is an autonomous transaction protocol (i.e.; algorithm) that automatically executes, controls, or documents valid events and actions according to the terms of a ‘contract’ or ‘agreement’ written into lines of code.

The smart contract can assign data within a blockchain to operate on conditions unique to the coded instructions within the smart contract. In a Windows environment, it is similar to an ‘executable’ (i.e.; .exe) file within a Dynamic Link Library (i.e.; .dll) file.

Given the strong influence of blockchain technology, I will explain the difference between a public and private blockchain, and how they apply to the novel characteristics of the invention.

A public blockchain is a permission-less blockchain (i.e.; anyone can ‘join’ the blockchain network). Therefore, public blockchains are decentralized, where no one has control over the network, but, once data is validated on the blockchain, it cannot be changed.

A private blockchain is a permissioned blockchain; such that permissioned networks place restrictions on not only who can participate in the network, but also in particular transactions, and by a set level. In comparing the two, ‘private’ can ‘open and close a window’, whereas ‘public’ can only ‘see through the window’.

By reviewing how, in a private blockchain, a component called Hyperledger achieves consensus through smart contracts; i.e.; autonomous transaction protocols, I believe the procedures defined in this application will reasonably outline the proposed invention. These opinions apply to the procedures:

(a) ‘Client’—the request (i.e.; ‘trigger’) via machine code referred to as “smart-contract data template” (SCDT) code, as it addresses the job request to the cumulative SOC background of the job-seeker via the SOC-embedded job request as posted by the hiring manager.
(b) ‘Consensus’—the proportional ratio alignment of hiring managers contributing SOC-based job descriptions. (i.e.; Ratios are proportional if they represent the same relationship; thus, if x-number of hiring managers declare the corresponding job requests are in alignment with, and compliance in SOC data, the result is that that SOC-based job description is general, and not common to that one company.)
(c) ‘Smart Contract’—the relative alignment of SCDT coded backgrounds of job-seekers to the SCDT's of the posted requests by the participating hiring managers. (Algebraically, b=[c≈a])

Hence, within a private blockchain environment, are the components required to process SOC and O'Net data (SEE: 0015-0017), associate the data (i.e.; consensus), and frame the data thru a document process.

In its basic explanation, a Hyperledger processes data within a blockchain like the function of a database engine. Hyperledger Fabric is a reference to the network-like components that manage oversight within a blockchain. One such Hyperledger Fabric, is IROHA.

For the record, Hyperledger IROHA is a distributed ledger framework, owned by The Linux Foundation, created in 2015. Hyperledger Fabric is an open-source, permissioned (i.e.; private) blockchain framework from the joint venture of the IBM Corporation and the Digital Asset Corporation, created in 2017. I claim, nor own, any proprietary rights to either component.

In accord with the provisions of the patent statutes, the principle and mode of operation of this invention are explained and illustrated in its chosen embodiment (i.e., Logical Data File Descriptions and User-Story Map). Yet, it must further be understood, that this invention may be practiced otherwise than as explicitly explained and illustrated, without departing from its spirit or scope.

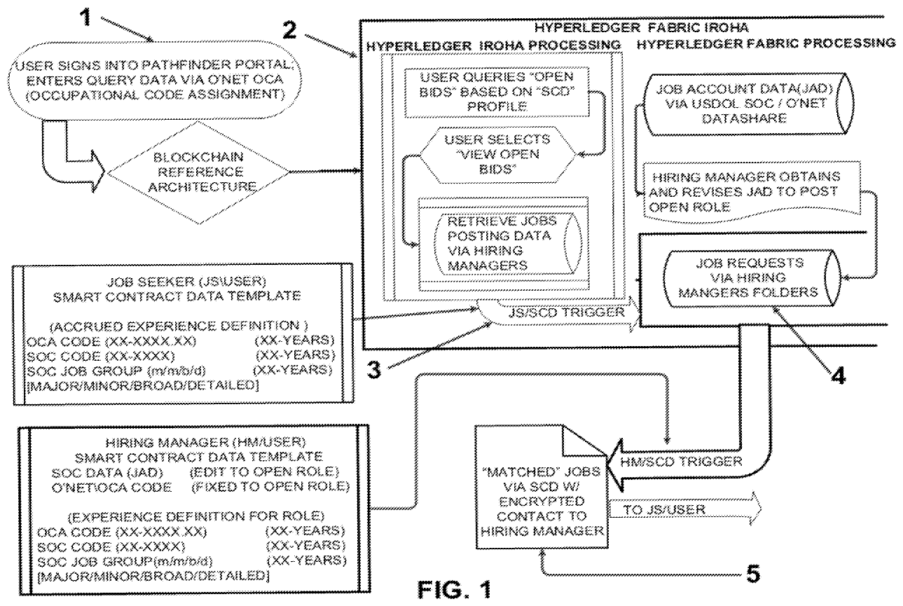

FIG. 1 is an exemplary schematic, prepared thru Logical Data File Description (LDFD), of the workflow of the process of a user sign-on to the system. It is understood that, Blockchain Reference Architectures (RA's) are environments where blockchain-based applications are hosted (i.e.; like a ‘web-page’).

(1) User queries on job by occupation, job title, or previous employment title via SOC/OCA data profile that is embedded with a SCDT algorithm (SEE: FIG. 1—‘Job Seeker (JS/USER) Smart Contract Data Template’).

Query processes within the Hyperledger IROHA (2); data fields populate ‘VIEW OPEN BIDS’. User would select ‘VIEW OPEN BIDS’, which triggers the data from data field, ‘Retrieve Jobs Posting Data via Hiring Managers’, shown in FIG. 1. Data accrued here comprising of near real-time data of roles posted by participating employers, matched by results of corresponding SCDT's (3) of collaborating consensus data of posted role, identified by job number as per SOC Major Group identification.

With the query being processed in the Hyperledger IROHA Processing (FIG. 1;2), data fields populate (FIG. 1;4) ‘Matched Jobs via SCDT/Encrypted Contact to Hiring Manager’, where data accrued here consisting essentially of the full amount of the user's SCDT populating data with corresponding SOC description of each job request posting, embedded with posting statistics (i.e.; AS OF DD:MM:YY) and the system-generated unique ID (UID) of the hiring manager (i.e.; encrypted non-viewable PII of HM's contact information).

User reviews data; User selects desired ‘Job Listing’, where data accrued here consisting essentially of consensus of job-seekers SCD to hiring manager's SCD and reviews data. User confirms data, triggering system data accrued here consisting essentially of generated datasheet of selection(s) to transmit to hiring managers blockchain eFolder.

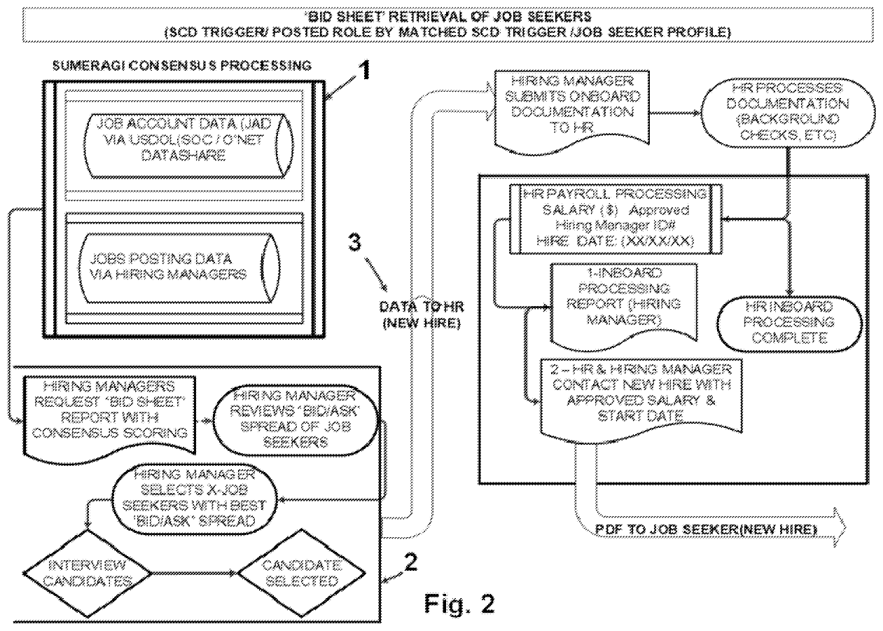

FIG. 2 is an exemplary schematic prepared thru Logical Data File Description (LDFD), of the workflow of the system process, ‘Bid-Sheet’ Retrieval of Job Seekers'. Data accrued here consisting essentially of ‘SCD Trigger-Posted Roles by Hiring Manager to Matched SCD Trigger of Job Seeker Profile’.

Query processes within Hyperledger IROHA (FIG. 2;1). Data accrued here comprising of consensus of hiring managers ‘Job Account Data (JAD) retrieved via USDOL-BLS O'Net/SOC Datashare’. Data builds (FIG. 2;2) system-generated datasheet of chosen job-seekers for hiring manager. Data accrued here comprising of consensus of hiring manager's SCDT data to job-seekers SCDT data. Hiring manager contacts job-seeker via system-generated ID for in-person or virtual interview.

Upon selection by hiring manager, system generates ‘New Hire’ (FIG. 2;3) datasheet of job-seeker for onboard processing. Data accrued here comprising of job-seekers information (i.e.; PII data) for inboard processing by HR. Data accrued here comprising of job-seekers PII data for background review, targeted salary, and hiring managers set date for “New Hire”. HR transmits system-generated “New Hire” datasheet (.pdf) approved by HR and hiring manager to job-seeker (.pdf). Data accrued here comprising of job-seekers ‘Start Date and Approved Salary’.

The relationship between the components exists when a user accesses system for a job-search which aligns with the embedded post date of the listing, (FIG. 1;3) to the time that the user places a request, thus, the user selects the best choices to compete for. (FIG. 1;3-4). System populates and generates the resulting “bids” onto the user's datasheet and transmits the “ask” to the hiring manager (FIG. 1;3). Hiring manager reviews the job-seekers “bid” to their “ask” of the job posting (i.e.; interviews the job-seeker; (FIG. 2;2), cumulating with sending the datasheet to HR for onboard processing (FIG. 2;3) of the potential applicant.

It is understood that, while the present invention has been defined in terms of a concise and thorough synopsis, it is understood that, by no means intended, that these descriptions in any way limit its scope. It is understood that, without departing from the spirit of this invention, its distinct substitutions, changes, and variations in the described synopsis, that the details of the method, the system and of their operation illustrated here, are possible by means of skilled application software engineers, without departing from the spirit of this invention.

Construction of the system portal can comprise of C++, JavaScript, and Android libraries. The data libraries within the Hyperledger IROHA are compatible with C++, JavaScript, and Android, to create InterPlanetary File System and asymmetric encryption of the system-generated documents and their required forms. This includes the forms for hiring managers to enter their job posting criteria information within the private blockchain, the Smart Contract Data Trigger (SCDT) data templates incorporated within the job-seekers and hiring managers schema (SEE: FIG. 1), and creating the code from the O'Net SOC Major Groups.

In order to establish and study the procedural events involved, a novel improvement of the present invention, is to exploit two (2) components used in application development; Logical Data Flow Descriptions (LDFD), and User-Story Maps.

In its basic explanation, logical DFD's (LDFD) are used as a model to show how a processes various communicating points utilize and collect data. In this fashion, a system built via LDFD is based upon business processes, such that the blueprint of the business processes will most likely continue to exist, with no true concern of the technology used to process them.

The LDFD's role, to see the process flow from end-to-end, take part in the developers and programmer's efforts in rendering the system's successive changes, subsequent phases, and progressive events into machine code.

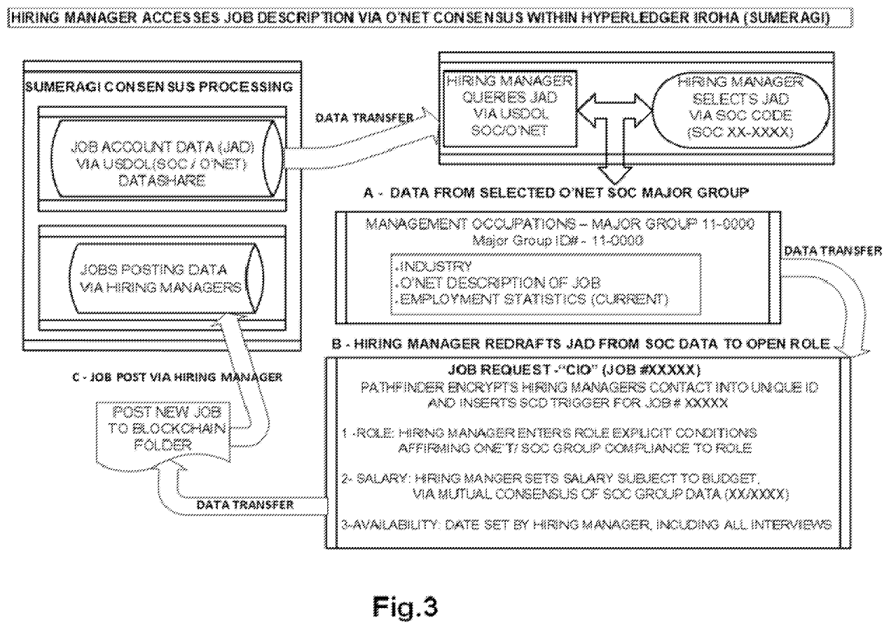

FIG. 3 is an exemplary schematic description of the “User-Story Map”. Data accrued here comprise of the visual workplan translating the systems functionalities, and how they would perform the process that are explained by means of the LDFD's. These are separated into phases called sprints, which are the intervals for constructing each component's machine code.

Within each section of the workplan, the programming team will have the User-Story map to guide the assembler (i.e.; a program that converts assembly language into machine code) in the path best aligned to the coding scheme, while the LDFD visually reconciles with the processes as they align, based upon the logic flow.

Data accrued here comprise the process for constructing the system portal, which coincide with the explanation of the use of the Hyperledger Fabric IROHA, and the integration of the use of SCDT's.

In its basic explanation, the SCDT is like a user profile access to a corporate exchange (i.e., office email), where blockchain smart contracts are the business protocols that execute set terms. Data accrued here comprise of ‘contracts’; encrypted credentials that defines hiring manager ‘users’ from job seeker ‘users’ within the Blockchain Reference Architecture (RA), which is the system which a blockchain processes its data.

Within the smart contract, encrypted into a unique ID (UID) for each separate user, are Personable Identifiable Information (PII) data. Data accrued here comprise the hiring manager's job title, email, and phone number, as well as the PII data of the job-seeker (name, address, email, phone contact). This UID is used as the traceable transaction between the hiring manager and job-seeker. (SEE: FIG. 1;5)

As such duties and responsibilities fall solely to the Hiring Manager, a novel improvement of the present invention, is its use for job description referencing and job request posting.

FIG. 3 is an exemplary schematic, prepared via LDFD, of the “Job Description Referencing” process. This process occurs when the hiring manager accesses job descriptions via USDOL SOC code, to correlate the OCA data related to the role. (FIG. 3; A)

By consensus processing of these OCA's the hiring manager can correctly clarify upon the job's details, without negatively influencing the duties required of it. (FIG. 3; A, B). Once the hiring manager has reviewed the SOC/OCA data, applies only the relevant and specific duties as they relate to the existing work environment and correlates 1:1 with the SOC/OCA of the job via USDOL description, the ‘Job Request’ is posted into the hiring manager's private blockchain folder. (FIG. 3; C)

In its basic explanation, this action can compare the SCDT algorithms in a SOC/OCA profile of a job-seeker in detecting the SCDT algorithm requirements of the hiring manager's job post. By this action, a hiring manager can find a new hire—or group of hires—in mere minutes, or possibly, seconds.

Data accrued here does not consist of nonessential requirements. Data of that sort regularly delays hiring and/or selection of candidates due to re-editing and drafting of roles within the job description which are inconsistent to the specific and concise needs of the hiring manager. (SEE: 0001-0004)

In its basic explanation, the Hyperledger IROHA “sorts” the job requests, and its Sumeragi algorithm achieves consensus of the SCDT data of a ‘contract’ of a hiring manager's job post (i.e.; specific and distinct requirements of a role, via SOC/O'Net consensus data), by way of the accrued SCDT data access of the private Blockchain ledgers, via the Hyperledger Fabric.

The present invention provides novel and useful improvements, methods, and processes on what currently exists. The data accrued here comprising of the job-seeker SCDT metadata, defines the job seeker's combined, professional disclosure of their craft (i.e.; cumulative experience). The system, PATHFINDER, via consensus processing, ‘matches’ job postings that result from a hiring manager's direct and specific requirements (REF: FIG. 3; C) through the Hyperledger. (REF: FIG. 1; 3,4,5).

In its basic explanation, the job seekers ‘smart contract’ data directly replaces the act of ‘tailoring a resume’, by means of reckoning the correlative data (i.e.; descriptive metadata) as per the SOC/OCA data, to the job that the job seeker is searching for. In balance, the hiring manger's ‘smart contract’ data will only ‘react’ to the correlative and descriptive metadata preset within the job post. It follows that, when a job-seeker receives a PATHFINDER-generated job match, it is as close to an in-depth match as realistically possible, given the data consensus.

FIG. 2;3 is a is an exemplary schematic, prepared via LDFD, of the “New Hire” process. This occurs when a hiring manager has identified through a system-generated “Bid-Sheet”, the candidate whose SCDT metadata aligns with the aspects (i.e.; the hiring manager's SCDT data within their job description) of the duties that the hiring manager has advertised through a PATHFINDER-generated job request. (REF: FIG. 2;2)

Once the job-seeker is interviewed (in-person or virtual) and selected as potential candidate for hire, the hiring manager transmits the PATHFINDER-generated ‘NEW HIRE” datasheet to Human Resources (HR) to onboard the new hire. (REF: FIG. 2;3).

This approach cancels the earlier mentioned problems. In its basic explanation, through use of the PATHFINDER system, the HR function will include, but not be limited to, appraisal of the hiring manager's job post for observing compliance of hiring practices (i.e.; OSHA, etc.), in addition to assessment of governmental employment guidelines (i.e.; Local, State, Federal). Finally, the HR function will include, but not be limited to, discharging the assumed duties as they relate to the onboarding processes (i.e.; background verification, processing of payroll, administration of employee benefits, etc.).

Although the preceding description contains significant detail, it should not be construed as limiting the scope of the invention, but rather providing illustrations of the preferred embodiments of the invention.

As an example, a database is an organized collection of structured information (i.e.; data) stored electronically within a computer system, which then can be accessed and/or modified.

A preferred embodiment within the invention is referred to as a Hyperledger Fabric, which is similar to a database, but does not utilize a relational database management system (RDBMS) tier. Such a variation would not materially alter the nature of the invention. Thus, the scope of the invention should be fixed by the following claims rather than any specific examples provided.

What is claimed is:

1. A method for management of job posting and candidate data within a blockchain environment, comprising of:
(a) a series of Logical Data Flow Descriptions (LDFD), in addition to a User-Story Map, to model the procedural events, also known as data flow, to generate the language code comprising of:
(b) an annotation tool that manages data transfer of US Department of Labor (USDOL) Standard Occupational Classification (SOC) and O'Net Occupational Code Assignment (OCA) job descriptions, and,
(c) an annotation tool that manages structured query requests implanted within the permission-based blockchain ledgers, termed as Smart Contract Data Template (SCDT) triggers, that automates and prioritizes user-defined data characteristics.

2. The process of claim 1, further comprising of the open-source, enterprise-grade, permissioned distributed, ledger technology (DLT) platform referred to as Hyperledger Fabric IROHA, as the processing component, where,
(a) USDOL data is collected for modifying and editing, and the newly retrieved and modified data can be accessed for consensus of collaborative context thru the Hyperledger, IROHA, and is secured via encrypted, private, permissioned blockchain folders within the Hyperledger Fabric framework, rendering the newly retrieved and modified data as authentic, acknowledged, and allocated information.

3. The process of claim 2, further comprising an alignment tool linked to the query tool to enable one or more query attributes, to be highlighted in an alignment function, that manages the retrieved data as well as processes the data, into an encrypted document which is electronically transmissible between participating entities within the Blockchain.
